(19) United States
(12) Patent Application Publication
(10) Pub. No.: US 2001/0016102 A1
(43) Pub. Date: Aug. 23, 2001

(54) Plug part for a combined optical and electrical plug-and-socket connection

(76) Inventor: Silverio De Marchi, Ascona (CH)

Correspondence Address: SHOEMAKER AND MATTARE, LTD., Crystal Plaza Building 1 - Suite 1203, 2001 Jefferson Davis Highway, Arlington, VA, 22202, US

(21) Appl. No.: 09/784,350

(22) Filed: Feb. 16, 2001

(30) Foreign Application Priority Data
Feb. 23, 2000 (EP) 00810154.5

(51) Int. Cl. G02B 6/38

(52) U.S. Cl. 385/75

(57) ABSTRACT

A plug part (1) for a combined optical and electrical plug-and socket connection has a plug housing (3) in which at least one plug pin with a light-wave guide is held. The cable (30) contains apart from a light-wave guide also yet at least one electrical lead, wherein the electrical contact is created via a contact element (13) which is held on the outside on the plug housing (3) and which extends in the plug longitudinal direction roughly parallel to the middle axis (29) of the plug pin. The contact element (4) is protected from external influences by a protective element (6) which may be snapped onto the plug housing (3).

The invention relates to a plug part for a combined optical and electrical plug-and-socket connection, according to the preamble of claim 1.

With numerous components of transmission technology it is necessary for various reasons to connect simultaneously an optical as well as an electrical lead. Since for the transmission of light on the one hand and electrical current on the other hand there are set differing demands, combined plug parts are relatively complicated to manufacture. It is therefore the object of the invention to provide a plug part of the above mentioned type which is simple to manufacture and with which the optical transmission properties given a perfect electrical contact are in no way compromised. In particular an already present plug part for an optical plug-and-socket connection is to be retrofitted with few additional parts, for a combined optical and electrical plug-and-socket connection. The plug part should in particular be suitable for constructing an electrical current circuit for the recognition and signalisation of the inserted optical connections

According to the invention this object is achieved with a plug part which has the features in claim 1. The design of the electrical contact as a separate contact element which is held on the outer side of the plug housing permits the use of an existing plug housing for optical plug-and-socket connections. The alignment of the contact element roughly parallel to the middle axis of the plug pin permits the position of the contact location of the electrical contact relative to the contact location of the optical contact to be adapted to the particular conditions. The contact element is at the same time advantageously formed as a contact strip whose cable-side end is held in a bend-protection for the cable. The electrical leading of the current is effected with this completely on the outer side of the plug housing without the plug housing having to have an exit opening or likewise for the electrical lead. The bend-protection which is necessary anyway on each plug part obtains in the simplest manner the additional function of a fastening element for the contact strip.

Preferably the contact element is surrounded by a protective element fixable on the plug housing. With this it is ensured that the electrically conducting parts lie exposed either before or after the insertion procedure. The protective element is at the same time snappable onto the plug housing in a particularly simple manner. In this manner the contact element is clamped firmly between the plug housing and the protective element.

A simple snap connection with this results when the plug housing at the cable-side end comprises a locking section extending over at least two sides and when the protective element comprises a roughly U-shaped locking bow which may be snapped onto the locking section. Locking sections on optical plug parts are already known, for example in order to connect two single-plugs, with the help of a snap-on connection element, into a duplex plug.

The contact element may laterally be additionally stabilised when the protective element in the section between the two Ulegs on the side proximal to the plug housing comprises a guide groove. The guide groove may accommodate the contact element over its whole length or over a part of its length.

For the perfect electrical contact the contact element on the end proximal to the plug end-face may comprise a resilient bend. The contact element with this is formed as a leaf spring which is biased towards the contact plane.

The plug part is particularly advantageously connected by way of a crimp sleeve to a light-wave guide cable which contains at least one electrical lead, wherein the electrical lead projects beyond the crimp sleeve and is in acting connection with the contact element. The crimp sleeve thus serves also for the strain relief of the electrical lead, and the contact of this with the contact element is effected without soldering or likewise. The crimp sleeve is over the whole outer casing surrounded by the bend-protection of the cable so that an electrcial insulation is guaranteed.

The protective element further advantageously comprises a receiving shaft for receiving a contact tongue connectable to the contact element. The receiving shaft thus protects the contact location also in the inserted condition.

With a plug-and-socket connection manufactured with a plug part according to the invention, the plug part is preferably inserted into a socket part, wherein the contact element partly overlaps the entry opening of the socket part. The electrical contact is thus closed in a region within the socket housing. In the region of the entry opening there is further arranged at least one relief which permits a part engagement of the protective element into the socket part. The socket housing is further of the same construction type as with conventional optical plug-and-socket connections.

The socket-side electrical counter contact may be directly integrated into the socket part, for example in the form of a contact tongue which is arranged in the region of the entry opening of the socket part. Alternatively the socket part may however also be assembled on a circuitboard in a manner such that it partly projects beyond an edge section of the circuitboard, wherein in the region of the socket part under the entry opening or under the relief in the region of the entry opening there is arranged a contact tongue on the circuitboard. The electrical counter contact is with this completely separated from the socket part and the electrical contact is created between the socket part and the circuitboard. This construction manner is particularly suitable for whole plug modules which are assembled on a circuitboard and which may be assembled on an apparatus wall as a plug-in module. Via the electrical contact one may ascertain whether an optical contact has been correctly inserted. Of course the electrical contact may also serve other purposes, for example for the additional transmission of electrical signals, etc. The plug part according to the invention may also be combined with a socket part which contains an element for transmitting and/or receiving light.

Further advantages and individual features of the invention result from the subsequent description of one embodiment example and from the drawings. There are shown in:

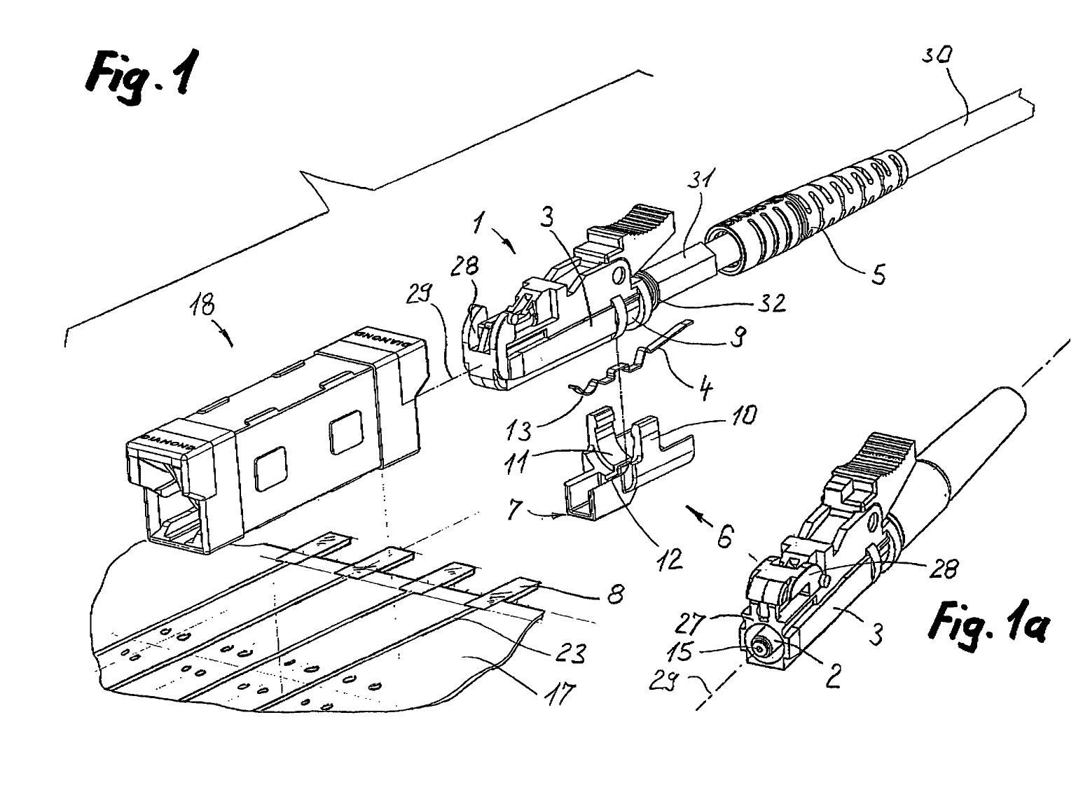

FIG. 1 a perspective representation of an optical plug-and-socket connection before the final assembly of the plug part,

FIG. 1a the plug housing of the plug part according to FIG. 1 with an opened protective lid,

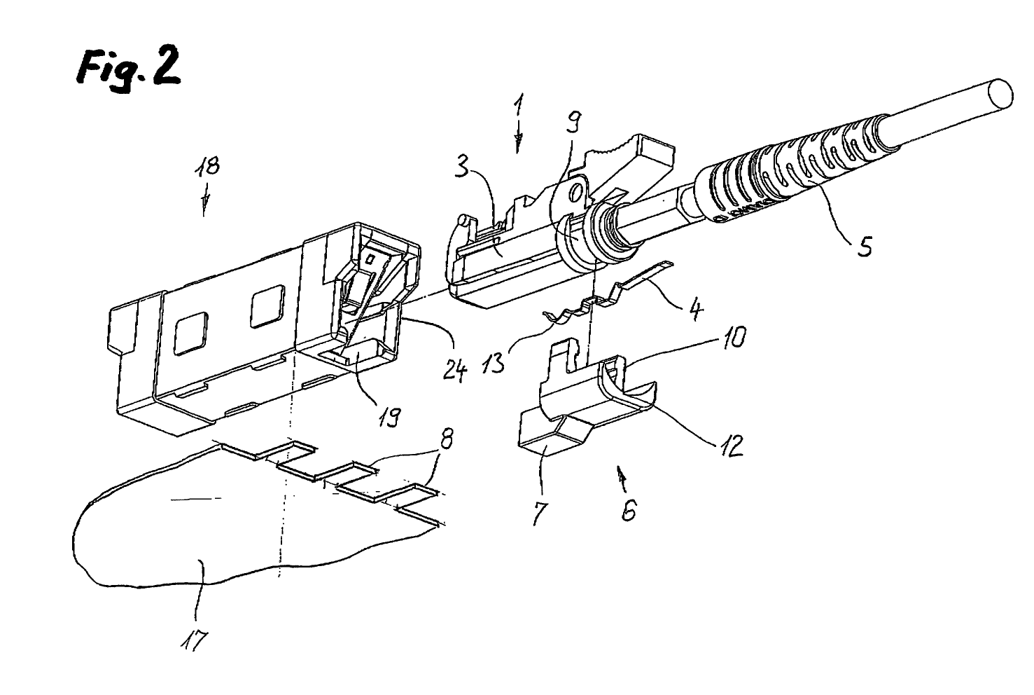

FIG. 2 the arrangement according to FIG. 1 from another viewing angle,

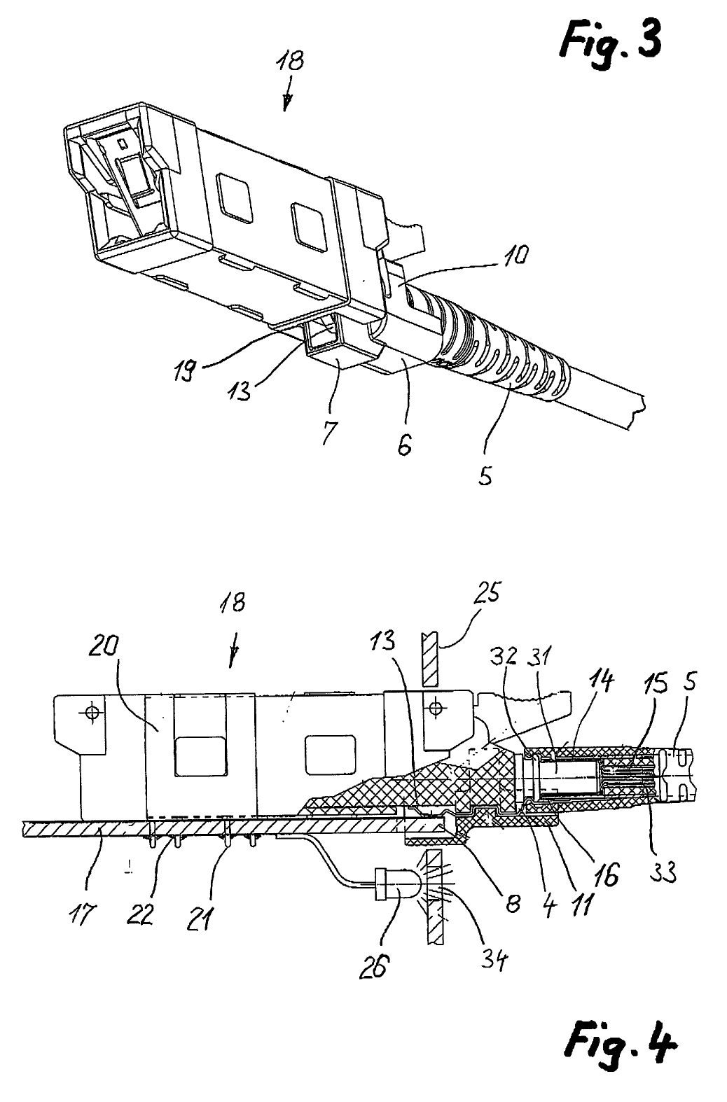

FIG. 3 a perspective representation between a socket part and a plug part according to FIG. 1 and

FIG. 4 a part cross section through the optical plug-and-socket connnection according to FIG. 3, assembled on a ciruitboard.

As is shown in the FIGS. 1 and 1a a plug part 1 consists of a plug housing 3 in which at least one plug pin 2 is held. In the centre of the plug pin and on its end-face there is held the actual light-wave guide 15. The end-face 27 of the plug housing 3 is in the uninserted condition covered with a protective lid 28 which on insertion into a socket part 18 automatically pivots up and is displaced back. With respect to the construction and manner of functioning of the optical plug-and-socket connection EPA-893 718 is referred to, whose disclosure is herewith expressly included in the present application.

The plug part 1 is connected to a cable 30 which apart from the actual light-wave guide also yet further contains an electrical lead. The transition region of the cable 30 to the plug part 1 is protected with a flexible bend-protection 5 which may be snapped onto a circumferential collar 32. A polygonal projection 31 serves for fastening the cable casing for the strain-relief, which is hereinafter described in more detail.

The electrical contact in the plug-and-socket connection is created via a contact element 4 which in the present case is designed as a metal strip. The cable-side end of the strip is with this bent such that it penetrates through the snap connection between the collar 32 and bend-protection 5 into the bend-protection and simultaneously is fixed by this. The end of the contact element 4 which is proximal to the plug end-face is provided with a resilient bend-up 13 which guarantees a reliable contact. The contact element extends in the plug longitudinal direction roughly parallel to the longitudinal middle axis 29 of the plug pin 2. The contact element is furthermore bent between its two ends in a manner such that is essentially follows the outer contour of the plug housing 3.

For the protection of the contact element 4 there is provided a protective element which may be snapped onto the plug housing 3. For this purpose the protective element is provided with a U-shaped locking bow 10 which may be snapped onto a locking section 9. The protective element is as the plug housing preferably manufactured of a plastic material. In the middle section 11 between the two U-legs of the locking bow 10 there is preferably arranged a guide groove 12 which is just sufficiently wide to accommodate the contact element 4. Thus the contact element obtains sufficient side stability in order also to be able to accommodate transverse forces. with the insertion procedure the forces which are in the axial direction are accommodated by suitable angled parts on the locking section 9.

The protective element 6 is further provided with a receiving shaft which in cross section is roughly U-shaped and is open towards the plug housing 3. This shaft surrounds the bend-up 13 of the contact element 4 at a sufficient distance in order yet to be able to accommodate a contact tongue 8 of a counter contact.

As is deduced from FIG. 2, the socket part 18 in the region of the entry opening 24 is provided with a relief 19. This relief permits an engagement of the receiving shaft 7 into the entry region of the socket part 18.

The socket part is in the present case invisaged to be fastened on a circuitboard 17. Preferably with this several socket parts are arranged directly next to one another. For the fastening there serve holding bows 20 (FIG. 4) whose feet 21 may be fastened at soldering locations 22. Further details of such holding bows or of alternative fastening types are for example evident from EP-A-974 854.

In the edge region of the circuitboard 17 at regular distances there are arranged contact tongues 8 to which in each case there leads a strip conductor 23. The socket parts 18 are fixed on the circuitboard 17 in a manner such that the relief 19 lies over a contact tongue 8. The engagement of the receiving shaft 7 into the relief 19 on the socket part 18 is evident from FIG. 3.

FIG. 4 shows yet further details of the fixation of the cable. For this purpose the cable casing 33 which as a rule consist of tear-proof fibres with the help of a crimping sleeve 14 is connected to the plug part or to the polygonal projection 31 in a pull-proof manner. Apart from the actual light-wave guide 15 the cable contains also an electrical lead 16 which in the region of the crimp sleeve is laid bare and which projects beyond this, or in the region of the collar 32 is bent up onto this. At this layed bare location the electrical lead 16 contacts the contact element 4, wherein the bend-protection 5 ensures a sufficient intensive contact.

From FIG. 4 it is furthermore also evident that the middle section 11 of the protective element 6 overlaps the region between the bend-protection and the plug housing so that the contact element 4 at no single location lies bare.

Finally FIG. 4 shows also the electrical contact between the contact tongue 8 and the bend-up 13 which in the inserted condition presses resiliently against the contact tongue. The relative position of the electrical contact is selected such that the electrical contact is only closed when the optical plug connection is created, i.e. when the plug pin has reached its end position in the socket part and the plug part locks in the socket part in a pull-proof manner. With the embodiment example according to FIG. 4 the electrical contact for this is used to activate a light diode 26 which is arranged behind an opening 34 of an apparatus wall 25. Additionally a monitoring system which here is not shown is activated which checks whether the correct plug part is allocated to the correct socket part and which where appropriate protocols the plug procedures.

1. A plug part (1) for a combined optical and electrical plug-and-socket connection, with a plug housing (3) in which at least one plug pin (2) with a light-wave guide (15) is held and with at least one electrical contact, characterised in that the electrical contact is formed as a separate contact element (4) which is held on the outer side of the plug housing (3) and which extends in the plug longitudinal direction roughly parallel to the middle axis (29) of the plug pin (15).

2. A plug part according to claim 1, characterised in that the contact element (4) is formed as a contact strip whose cable-side end is held in a bend-protection (5) for the cable (30).

3. A plug part according to claim 1 or 2, characterised in that the contact element (4) is surrounded by a protective element (6) fixable on the plug housing (3).

4. A plug part according to claim 3, characterised in that the protective element (6) comprises a receiving shaft (7) roughly U-shaped in cross section, for receiving a contact tongue (8) connectable to the contact element (4).

5. A plug part according to one of the claims 3 or 4, characterised in that the protective element (6) is snappable onto the plug housing (3).

6. A plug part according to claim 5, characterised in that the plug housing (3) at the cable-side end comprises a locking section (9) extending over two sides and that the protective element (6) comprises a roughly U-shaped locking bow (10) which is snappable onto the locking section.

7. A plug part according to claim 6, characterised in that the protective element (6) in the section (11) between the two U-legs on the side proximal to the plug housing comprises a guide groove (12) for the lateral stabilisation of the contact element.

8. A plug part according to one of the claims 1 to 7, characterised in that the contact element (4) at the end proximal to the plug end-face (27) comprises a resilient bend-up (13).

9. A plug part according to one of the claims 1 to 8, characterised in that the plug part by way of a crimp sleeve (14) is connected to a cable (30) which contains at least one electrical lead (16) and that the electrical lead projects beyond the crimp sleeve and is in acting connection with the contact element (4).

10. A plug-and-socket connection with a plug part according to one of the claims 1 to 9, characterized in that the plug part is inserted into a socket part (18), wherein the contact element (4) partly overlaps the entry opening (24) of the socket part and that in the region of the entry opening there is arranged at least one relief (19).

11. A plug and-socket connection according to claim 10, characterised in that the socket part (18) is assembled on a circuitboard (17) in a manner such that is partly projects beyond an edge section of the circuitboard, wherein in the region of the socket part under the reliefs (19) there is arranged a contact tongue (8) on the circuitboard.
